(19) United States
(12) Patent Application Publication
(10) Pub. No.: US 2008/0154937 A1
(43) Pub. Date: Jun. 26, 2008

(54) System and method for generic output management

(75) Inventors: Juergen Sattler, Wiesloch (DE); Olaf Meincke, Heidelberg (DE); Joachim Gaffga, Wiesloch (DE)

Correspondence Address: KENYON & KENYON LLP, 1500 K STREET N.W., WASHINGTON, DC, 20005, US

(73) Assignee: SAP AG

(21) Appl. No.: 11/643,797

(22) Filed: Dec. 22, 2006

(51) Int. Cl. G06F 17/30

(52) U.S. Cl. 707/102; 707/E17.014

(57) ABSTRACT

A system and method for generic output management. According to an embodiment of the invention, an engine receives a request to provide output based on a form template, the request including an identifier associated with the form template, retrieves from a data store meta-data associated with the form template identifier, the meta-data specifying how to retrieve data referenced in the form template from one or more data sources external to the form template, utilizes the meta-data to retrieve the referenced data, assembles the retrieved data into a format for delivery to a form rendering engine, and provides the assembled data to the form rendering engine to be associated with a form to be generated based on the form template.

### BACKGROUND OF THE INVENTION

An abundance of computer systems and applications rely on the use of forms to present data in a structured format. Forms that present data that is dynamically retrieved from external data sources are usually generated at run time based on a form template.

A form template is generally defined by a user at design time to specify a form layout and form data to be retrieved from external data sources, so that a form rendering engine may subsequently process the form template at run time to generate the desired form. In many circumstances, a user must manually code the programming logic required by the form rendering engine to retrieve the form data from a particular data source.

However, due to evolving system requirements and other factors, it is common for the structure of data in an external data source to be modified. When such changes occur, any form template that references an older representation of the data becomes outdated and needs to be updated. The process of updating external form data references usually requires manual recoding of the data retrieval logic, which is time consuming and labor intensive—especially when a large amount of form templates are affected.

Accordingly, there is a need in the art for a system and method that addresses the shortcomings associated with updating form data references to external data sources.

### BRIEF DESCRIPTION OF THE DRAWINGS

FIG. 1 is a block diagram that depicts a system architecture in accordance with an embodiment of the present invention.

FIG. 2 is a process flow diagram that depicts a form template generation process in accordance with an embodiment of the present invention.

FIG. 3 is a process flow diagram that depicts a generic output management process in accordance with an embodiment of the present invention.

FIG. 4 is a block diagram that depicts content of form meta-data in accordance with an embodiment of the present invention.

FIG. 5 is a block diagram that depicts a computing device in accordance with an embodiment of the present invention.

### DETAILED DESCRIPTION

Embodiments of the present invention address the shortcomings associated with updating form data references to external data sources by providing a generic service for form data retrieval. Instead of dedicated data retrieval code being written for each form template, the same generic data retrieval code can be utilized to retrieve data for any form template. This can be achieved by generating meta-data in connection with each form template that specifies how its data is to be retrieved from a data source in a way the generic data retrieval code understands. In this manner, if the structure of any data changes, only the corresponding meta-data would need to be updated—not the data retrieval code.

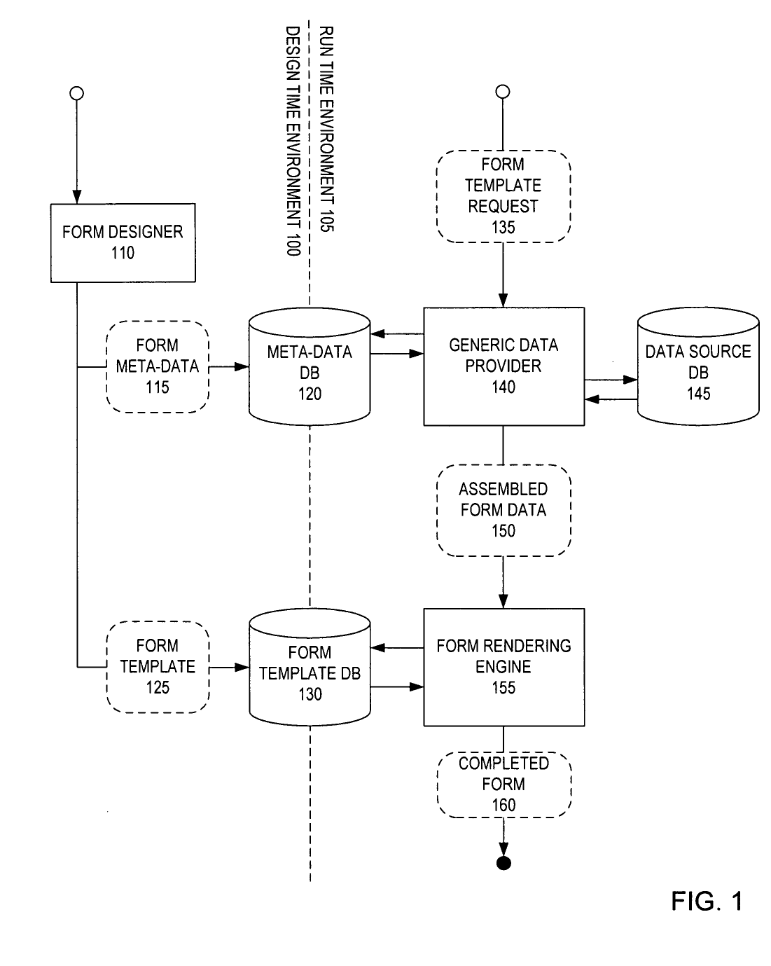

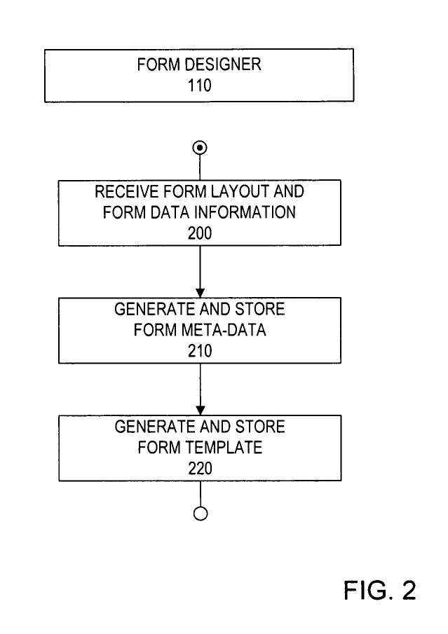

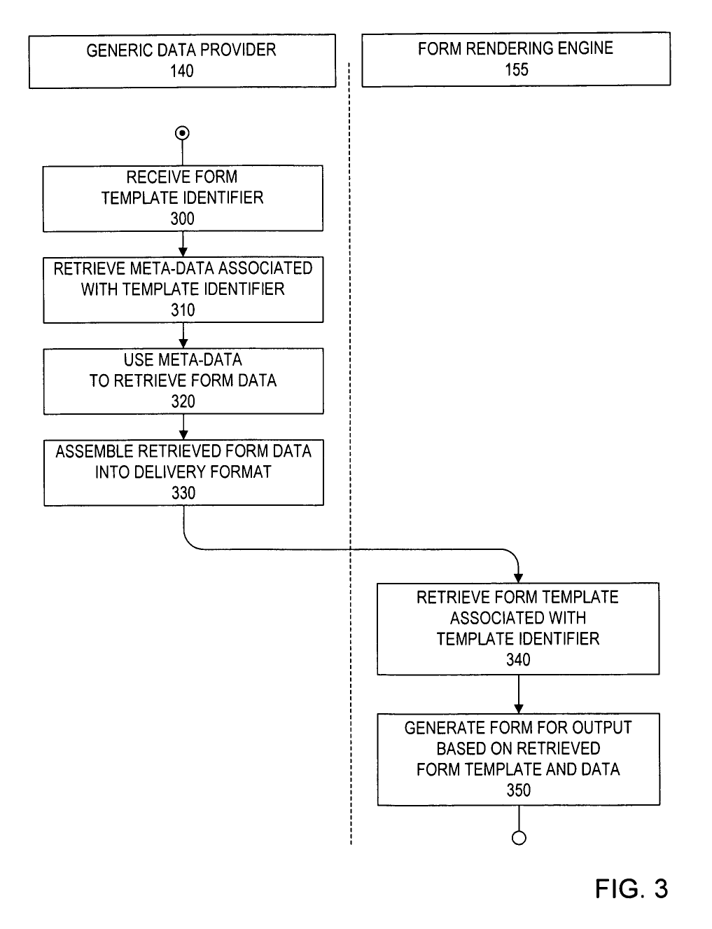

FIG. 1 portrays a design time (100) and run time (105) environment in accordance with an embodiment of the present invention. The design time environment (100) may operate in accordance with the steps of FIG. 2, and the run time environment (105) may operate in accordance with the steps of FIG. 3.

The design time environment (100) allows for generic data retrieval information (i.e., data retrieval information that can be understood and processed by the generic data retrieval code) to be generated in connection with a particular form template, while the run time environment (105) allows for form rendering based on the form template and its generic data retrieval information.

In connection with the design time environment (100), a form designer (110) may first receive form layout and form data information to be associated with a form template (125) (step 200). The form layout and form data information may be received from a user via a graphical user interface, for example.

In order to allow for generic data retrieval information to be generated as described above, the form designer (110) may generate meta-data (115) associated with the form data information and store the meta-data (115) in a meta-data database (120) (step 210). The form designer (110) may then generate the form template (125) based at least in part on the layout information, and store the form template (125) in a form template database (130) (step 220).

In connection with the run time environment (105), in order to allow for form rendering based on the form template and its generic data retrieval information, a generic data provider (140) may first retrieve the meta-data (115) from the meta-data database (120) (step 310) upon receiving a request (135) to provide output based on the form template (125) (step 300). Such a request may include an identifier associated with the form template (125), for example.

The generic data provider (140) may then utilize the meta-data (115) to retrieve from a data source database (145) the form data that is referenced in the form template (125) (step 320). Once retrieved, the data may be assembled (150) into a format for delivery to a form rendering engine (155) (step 330), where it can be associated with a form to be generated based on the form template (125). The assembled data may be formatted in a hypertext markup language, such as XML for example, and in accordance with a data schema correlating to the structure of the form template (125) data.

Upon receiving the assembled data (150) along with the form template identifier from the generic data provider (140), the form rendering engine (155) may retrieve the form template (125) associated with the identifier from the form template database (130) (step 340) and generate a form (160) for output based on the retrieved form template (125) and received data (step 350).

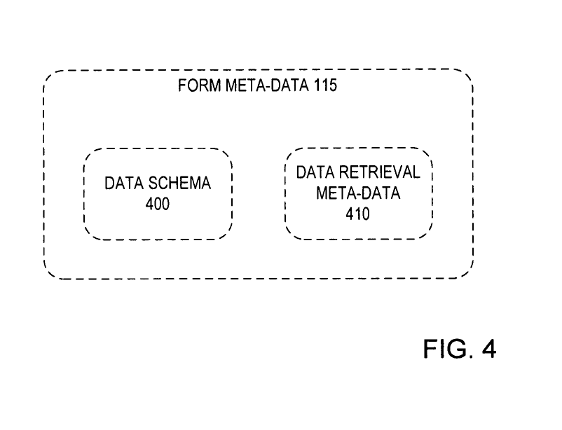

FIG. 4 illustrates an embodiment of meta-data (115), which may include a data schema (400) describing a structure of the form template (125) associated with the referenced form data, and data retrieval meta-data (410) describing data source and navigation information associated with the retrieval of the referenced form data. The meta-data (115) may be organized in accordance with any format. The data schema could be arranged in XML, and the data retrieval meta-data could be arranged according to any database format, for example.

The form designer (110) and form rendering engine (155) may be built from the ground up in accordance with embodiments of the present invention, or standard designers and output engines may be modified to exercise embodiments of the present invention.

For example, a module could be integrated with or work in conjunction with a known form designer to provide a user interface for both allowing a user to select the external data to be incorporated into a form template (125), and generating and storing the corresponding form meta-data 115 as described above.

Likewise, a module could be integrated with or work in conjunction with a known output engine to process the assembled form data (150) in generating the completed form (160), or integrating the assembled form data (150) into the form template (125) for known output processing by the output engine, for example.

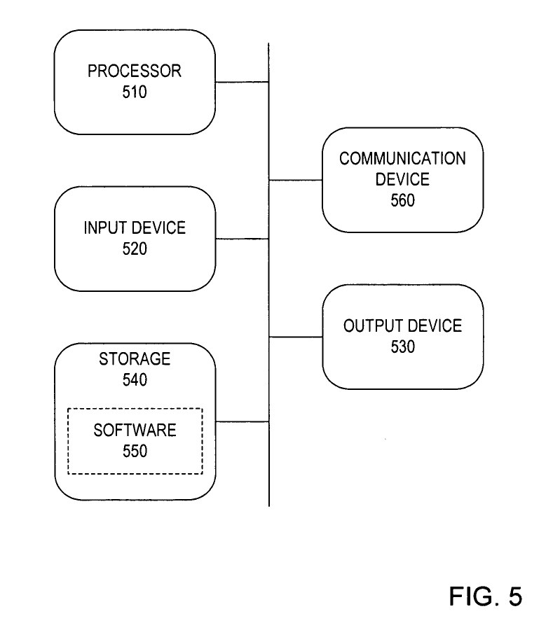

FIG. 5 illustrates the components of a basic computing device in accordance with an embodiment of the present invention, which may run the form designer (110), generic data provider (140) and form rendering engine (155). The computing device may be a workstation, server, personal computer, handheld computing device, or any other type of microprocessor-based device. The computing device may include one or more of a processor (510), input device (520), output device (530), storage (540), and communication device (560).

The input device (520) may include a keyboard, mouse, pen-operated touch screen or monitor, voice-recognition device, or any other device that provides input. The output device (530) may include a monitor, printer, disk drive, speakers, or any other device that provides output.

The storage (540) may include any volatile and/or nonvolatile data storage, including one or more electrical, magnetic or optical memories such as a RAM, cache, hard drive, CD-ROM drive, tape drive or removable storage disk. Communication device 560 may include a modem, network interface card, or any other device capable of transmitting and receiving signals over a network. The components of the computing device may be connected in any manner, such as via electrical bus or wirelessly.

The software (550), which may be stored in the storage (540) and executed by the processor (510), may include, for example, the application programming that embodies the functionality of the present invention (e.g., as embodied in the form designer (110), generic data provider (140) and form rendering engine (155), and in their corresponding components). The software (550) may include a combination of client applications and enterprise servers such as an application server and a database server.

Communications in connection with the present invention may occur over any type of interconnected communication system/network, may implement any communications protocol, and may be secured by any security protocol. Corresponding network links may include telephone lines, DSL, cable networks, T1 or T3 lines, wireless network connections, or any other arrangement that implements the transmission and reception of network signals.

The computing device may implement any operating system, such as Windows or UNIX. The software (550) may be written in any programming language, such as ABAP, C, C++, Java or Visual Basic. In various embodiments, application software embodying the functionality of the present invention may be deployed on a standalone machine, in a client/server arrangement or through a Web browser as a Web-based application or Web service, for example.

Several embodiments of the invention are specifically illustrated and/or described herein. However, it will be appreciated that modifications and variations of the invention are covered by the above teachings and within the purview of the appended claims without departing from the spirit and intended scope of the invention.

For example, software components that may implement embodiments of the present invention such as the form designer (110), generic data provider (140) and form rendering engine (155) may comprise several discrete modules (other than those shown in FIG. 1) that together still provide the same functionality, data specified in the illustrated data stores (120, 130 and 145) may reside in one database or be spread over several databases and/or systems, and the flow diagram of FIGS. 2 and 3 may encompass combined steps or several intermediate steps that do not detract from the higher level functionality described therein.

What is claimed is:

1. A system for generic output management, comprising:
a form meta-data database;
a form template database;
a data source database;
a form designer engine communicatively linked to the form meta-data database and form template database, wherein the form designer engine
receives form layout and form data information to be associated with a form template,
generates meta-data associated with the form data information, the meta-data specifying how to retrieve form data from the data source database, and stores the meta-data in the form meta-data database, and
generates the form template based at least in part on the form layout information, and stores the form template in the form template database;
a generic data provider engine communicatively linked to the form meta-data database and the data source database, wherein the generic data provider engine
receives a request to provide output based on the form template,
retrieves from the form meta-data database the meta-data associated with the form template,
utilizes the meta-data to retrieve the form data from the data source database, and
assembles the retrieved data into a format for delivery to a form rendering engine; and
the form rendering engine communicatively linked to the form template database, wherein the form rendering engine
receives the assembled data from the generic data provider,
retrieves the form template from the form template database, and
generates a form for output based on the retrieved form template and received data.

2. The system of claim 2, wherein the form designer engine receives the form layout and form data information from a user via a graphical user interface.

3. The system of claim 1, wherein the meta-data includes a data schema describing a structure of the form template associated with the form data, and data retrieval meta-data describing data source and navigation information associated with the retrieval of the form data.

4. The system of claim 3, wherein the assembled data is formatted in a hypertext markup language in accordance with the data schema.

5. The system of claim 4, wherein the hypertext markup language is XML.

6. A method for generic output management, comprising:
receiving a request to provide output based on a form template, the request including an identifier associated with the form template;
retrieving from a data store meta-data associated with the form template identifier, the meta-data specifying how to retrieve data referenced in the form template from one or more data sources external to the form template;
utilizing the meta-data to retrieve the referenced data;
assembling the retrieved data into a format for delivery to a form rendering engine; and
providing the assembled data to the form rendering engine to be associated with a form to be generated based on the form template.

7. The method of claim 6, wherein the meta-data includes a data schema describing a structure of the form template associated with the referenced data, and data retrieval meta-data describing data source and navigation information associated with the retrieval of the referenced data.

8. The method of claim 7, wherein the assembled data is formatted in a hypertext markup language in accordance with the data schema.

9. The method of claim 8, wherein the hypertext markup language is XML.

10. A method for generic output management, comprising:
receiving, at a form rendering engine, data referenced in a form template and retrieved from one or more data sources external to the form template, the data having been
retrieved based on meta-data associated with an identifier of the form template and specifying how to retrieve the data, and
subsequently assembled into a format for delivery to the form rendering engine;
retrieving the form template from a data store; and
generating a form for output based on the retrieved form template and received data.

11. The method of claim 10, wherein the meta-data includes a data schema describing a structure of the form template associated with the referenced data, and data retrieval meta-data describing data source and navigation information associated with the retrieval of the referenced data.

12. The method of claim 11, wherein the assembled data is formatted in a hypertext markup language in accordance with the data schema.

13. The method of claim 12, wherein the hypertext markup language is XML.
